(19) United States
(12) Patent Application Publication
(10) Pub. No.: US 2017/0294266 A1
(43) Pub. Date: Oct. 12, 2017

(54) BOBBIN ASSEMBLY AND METHOD FOR PRODUCING A BOBBIN ASSEMBLY

(71) Applicant: KONINKLIJKE PHILIPS N.V., EINDHOVEN (NL)

(72) Inventors: BERND ACKERMANN, EINDHOVEN (NL); PETER LÜRKENS, EINDHOVEN (NL); ALBERT GARCIA TORMO, EINDHOVEN (NL)

(21) Appl. No.: 15/507,309

(22) PCT Filed: Sep. 1, 2015
(86) PCT No.: PCT/EP2015/069961

§ 371 Date: Feb. 28, 2017

(30) Foreign Application Priority Data
Sep. 2, 2014 (EP) 14183204.8

(51) Int. Cl. H01F 27/32; H01F 27/28; H01F 41/12

(52) U.S. Cl. CPC H01F 27/325; H01F 41/125; H01F 27/2823

(57) ABSTRACT

The present invention relates to a bobbin assembly (1000-3) comprising: a plurality of winding slots (1000-4), each of which comprises a winding (10) with one turn per layer; and a plurality of isolation slots (1000-5), each of which comprises one single loop of the winding (10), and each of the isolation slots (1000-5) is adjacent to at least one winding slot (1000-4) of the plurality of winding slots (1000-4), and each of the winding slots (1000-4) is adjacent to at least one isolation slot (1000-5) of the plurality of isolation slots (1000-5).

### FIELD OF THE INVENTION

The present invention relates to the field of bobbins for coils. Particularly, the present invention relates to a bobbin assembly and a method for producing a bobbin assembly.

### BACKGROUND OF THE INVENTION

Transformers for high-voltage generation deliver voltages in the range of tens of kilovolts, referring to a voltage difference between the ends of the transformers' secondary port. Internally, this voltage difference equally distributes across all the turns in the secondary winding, so that the voltage progressively builds up along the wire. Typically, secondary bobbins comprise many slots with long and thin walls, with a width of for instance 1 mm.

U.S. Pat. No. 4,462,016 A1 describes an inductor coil with mechanically coupleable bobbins. The therein described inductor coils comprise a main winding of insulated wire on the barrel of a bobbin having two axial lugs salient from one of the bobbin's end flanges, and having two recesses formed in the outer surface of the other of such flanges.

US 2008/0284551 A1 describes transformers and winding units thereof. The therein described transformers comprise a ferromagnetic core unit; a bobbin coupled with the ferromagnetic core unit; at least a winding unit as a primary winding and at least a plate as a secondary winding. Also, some of the winding units can act as a secondary winding. At least a winding unit and at least a plate are alternatively stacked in a staggered manner. A conductive wire is wound around the winding unit.

US 2011/0115598 A1 describes a bobbin structure and transformer having the same. The therein described bobbin structures comprise plural modular bobbin members connected with each other. Each modular bobbin member comprises a perforation channel, a first baffle disposed on one end of the perforation channel and placed perpendicularly to the perforation channel, and a second baffle disposed on the other end of the perforation channel and placed oppositely to the first baffle.

US 2010/0214049 A1 describes a transformer capable of driving a plurality of lamps with one transformer by increasing the number of outer bobbins wrapping an outer circumferential surface of an inner bobbin wound by a coil and the number of output terminals by winding other coils around the outer bobbins.

### SUMMARY OF THE INVENTION

There may be a need to improve bobbins for coils. These needs are met by the subject-matter of the independent claims. Further exemplary embodiments are evident from the dependent claims and the following description.

An aspect of the present invention relates to a bobbin assembly comprising a plurality of winding slots, each of which comprises a winding with multiple loops of the winding with one turn per layer; and a plurality of isolation slots, each of which comprises one single loop of the winding, and each of the isolation slots is adjacent to at least one of the plurality of winding slots, and each of the winding slots is adjacent to at least one of the plurality of isolation slots.

In other words, the isolation slots may usually comprises one single loop of the winding.

A further, second aspect of the present invention relates to an inductive electrical component comprising at least one a bobbin assembly according to the first aspect of the present invention or according to any implementation form of the first aspect of the present invention.

A further, third aspect of the present invention relates to a medical imaging system comprising at least one inductive electrical component according to the second aspect of the present invention or according to any implementation form of the second aspect of the present invention.

A further, fourth aspect of the present invention relates to a method for producing a bobbin assembly, the method comprising the steps of: providing a first building block comprising a first opening and guiding a wire through the first opening into the first building block; providing a second building block comprising a second opening being larger than the first opening and guiding the wire through the second opening into the second building block; and assembling the bobbin assembly comprising: a plurality of winding slots, each of which comprises a winding with multiple loops of the winding with one turn per layer; and a plurality of isolation slots, each of which comprises one single loop of the winding, using the first and second building blocks.

The present invention advantageously proposes a winding which has only one turn per layer in any given slot. Each turn will have only one or two other turns in its immediate neighborhood.

The present invention advantageously provides a bobbin for a secondary winding comprising a large number of narrow slots. The present invention advantageously allows that a voltage between adjacent turns will have a minimum possible value. The present invention advantageously allows that a capacitance will be minimized and also the danger of flashovers is minimized.

The present invention advantageously allows that a reduced number of mistakes and deviations may occur during manufacturing of the winding arrangement and turns with larger voltages between them cannot be placed next to each other.

The present invention advantageously allows that high-voltage transformers operating at high frequency do not need many turns to accommodate for the admitted core induction, meaning that the voltage between layers becomes very high, even if there are only few turns.

The present invention advantageously provides that if the winding process progresses from one slot to the next, i.e. not back to slots which have already been filled with turns, no wrong winding can occur in the winding arrangement and turns with larger voltages between them cannot be placed next to each other.

The term “adjacent” as used by the present invention may refer to an arrangement where, for instance, a first building block is arranged next to a second building block, and the first building block can be coupled to the second building block.

According to an exemplary embodiment of the present invention, each winding slot of the plurality of winding slots and each isolation slot of the plurality of isolation slots is configured to receive a secondary winding as the winding.

This advantageously restricts the occurring voltage differences to reduced voltage differences between adjacent wires of the winding.

According to an exemplary embodiment of the present invention, each winding slot of the plurality of winding slots and each isolation slot of the plurality of isolation slots is formed by a building block. This advantageously allows providing an improved modular building, e.g. a high degree of modularity, the degree to which a system's components may be separated and recombined.

According to an exemplary embodiment of the present invention, each of the building blocks comprises a first connector module and a second connector module and the first connector module and the second connector module are configured to be coupled with an adjacent building block. This advantageously allows a modular approach for fabricating the bobbin assembly.

According to an exemplary embodiment of the present invention, the first connector module is an inner thread and the second connector module is an outer thread.

This advantageously allows a mechanically stable coupling of the adjacent building blocks.

According to an exemplary embodiment of the present invention, each of the building blocks comprises an opening, which is configured to pass the winding through. This advantageously allows a secure and safe winding process.

According to an exemplary embodiment of the present invention, each of the building blocks is substantially disc-shaped. This advantageously allows an increased efficiency of the coils fabricated out of the bobbin assembly.

The term “substantially disc-shaped” as used by the present invention may refer to an object with a circular shape, for instance a solid of revolution or a disc, a cylinder, wherein the radius is higher by a multiple than the thickness, for instance 5 times.

According to an exemplary embodiment of the present invention, each of the building blocks comprises a disc portion and a tube portion. This advantageously allows to build up thick winding layers by adjusting the tube portion length according to the desired winding layer width.

According to an exemplary embodiment of the present invention, the bobbin assembly is configured to be operated with a voltage of up to 1 kV, preferably of up to 10 kV and particularly preferred of up to 80 kV. This advantageously allows supplying AC voltage to the high-voltage cascade being a part of the X-ray generator. The high-voltage cascade may amplify, rectify, and smoothen the AC voltage and may supply the resulting DC voltage to the X-ray tube.

According to an exemplary embodiment of the present invention, the bobbin assembly is a secondary winding bobbin assembly in a transformer further comprising a primary winding bobbin assembly and wherein a a boosting turns ratio is higher than 1, preferably higher than 4 and particularly preferred higher than 10. This advantageously allows improving the efficiency of the high-voltage generator.

### BRIEF DESCRIPTION OF THE DRAWINGS

A more complete appreciation of the present invention and the attendant advantages thereof will be more clearly understood by reference to the following schematic drawings, which are not to scale, wherein:

FIG. 1 shows a schematic diagram of a building block according to an exemplary embodiment of the present invention;

FIG. 2 shows a schematic diagram of a bobbin assembly according to an exemplary embodiment of the present invention;

FIG. 3 shows a schematic diagram of a modular building block according to an exemplary embodiment of the present invention;

FIG. 4 shows a schematic diagram of a bobbin assembly according to an exemplary embodiment of the present invention;

FIG. 5 shows a schematic diagram of a bobbin assembly for explaining the present invention;

FIG. 6 shows a schematic diagram of a flow-chart diagram of a method for producing a bobbin assembly according to an exemplary embodiment of the present invention;

FIG. 7 shows a schematic diagram of a medical imaging system according to an exemplary embodiment of the present invention.

### DETAILED DESCRIPTION OF EMBODIMENTS

The illustration in the drawings is purely schematic and does not intend to provide scaling relations or size information. In different drawings, similar or identical elements are provided with the same reference numerals. Generally, identical parts, units, entities or steps are provided with the same reference symbols in the description.

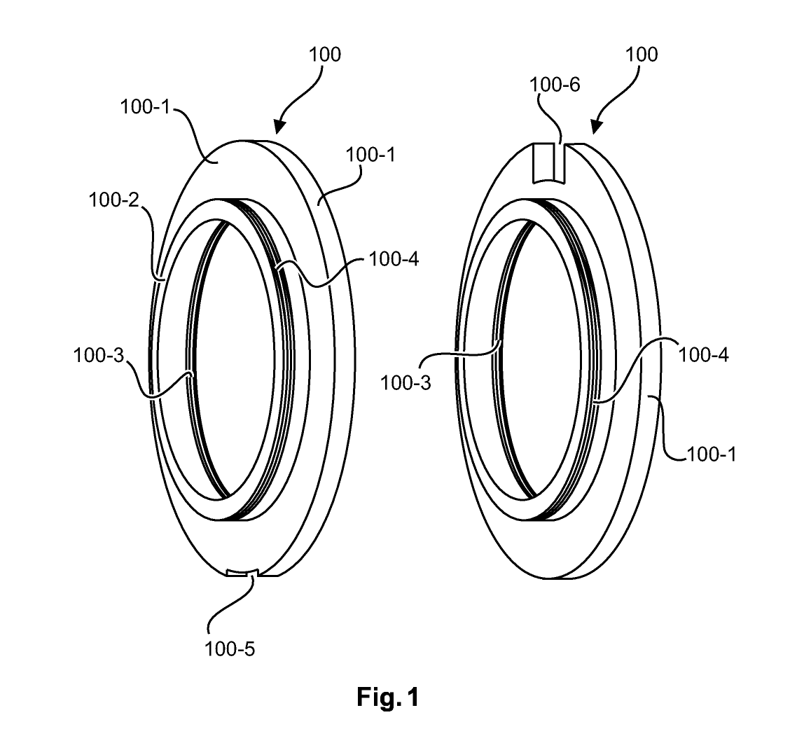

FIG. 1 shows a schematic diagram of a modular building block according to an exemplary embodiment of the present invention.

A building block 100 may comprise a disc portion 100-1 and a tube portion 100-2. Further, the building block 100 may comprise a first connector module 100-3 and a second connector module 100-4.

The first connector module 100-3 may be constructed as an inner thread for the case of a disc-shaped building block. The second connector module 100-4 may be constructed in form of an outer thread for the case of a disc-shaped building block 100. The building block may further comprise an opening 100-5, which is configured to pass the winding through it.

On the right side, in FIG. 1, a second type of building block is shown, which in contrast to the first type of building block 100 as shown on the left side of the FIG. 1, comprises a different opening 100-6 instead of the opening 100-5.

The second kind of opening 100-6 is compared to the first type of opening 100-5 larger. In other words, of the two discs or building blocks 100 as shown in FIG. 1, one disc has a small opening 100-5 at the outer diameter, to realise an exit for the winding wire from the fully wound slot. The other type, e.g. the second type, has a long slot opening as an entry for the wire from the preceding winding chamber, beginning filling the new chamber.

According to an exemplary embodiment of the present invention, the threads lock the discs without any shift, so that the small and long openings may be shifted 180° with respect to an axis of rotational symmetry of the bobbin assembly.

According to an exemplary embodiment of the present invention, the building block 100 may be hollow, so that the primary bobbin and the core can be accommodated in the inner space. The building block 100 has an inner thread to be connected with other modular elements; the tube ends with an outer thread to be connected to other modular elements.

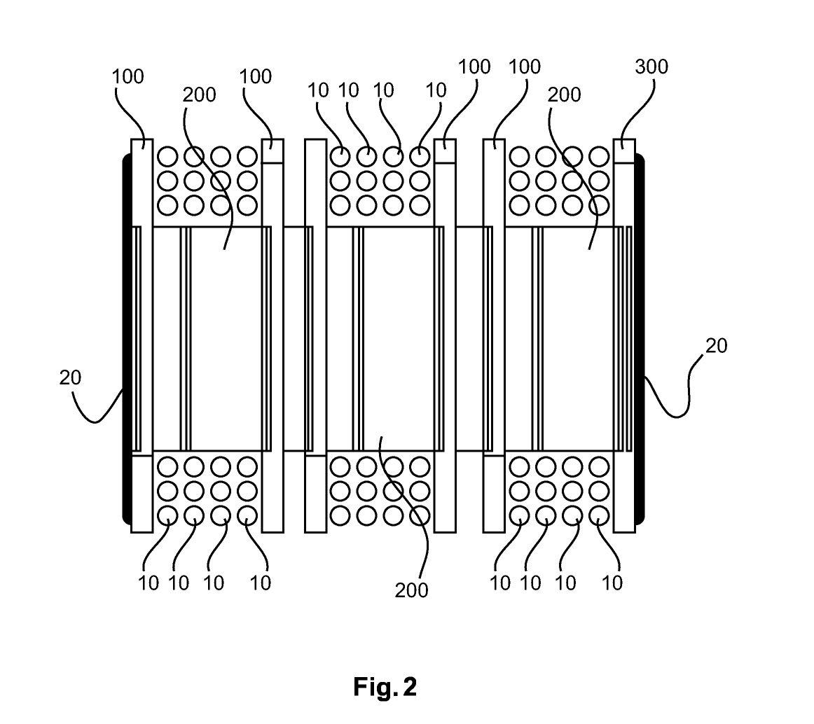

FIG. 2 shows a bobbin assembly according to an exemplary embodiment of the present invention.

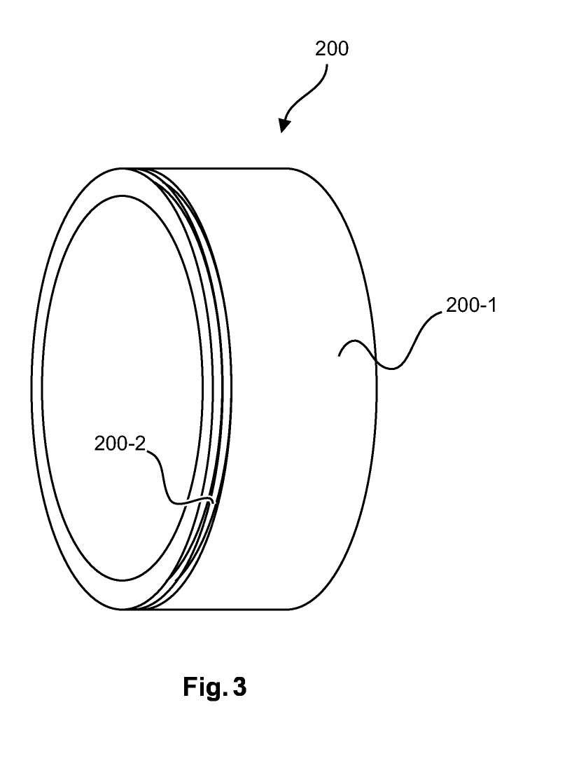

Using building blocks 100 and the modular separator 200 as later shown in detail in FIG. 3, a bobbin assembly could be constructed as shown in FIG. 2. The bobbin starts with a modular disc in form of a building block 100 with a large opening on the bottom. A separator in form of a modular separator 200 is used to provide enough slot width to accommodate all turns. Then another modular disc in the form of a building block 100 is used, this one with a small opening on top, small since the opening may be smaller than the large opening on the bottom. Then a modular separator 200 follows, the pairs of building block 100 and modular separator 200 are as many times repeated as demanded.

According to an exemplary embodiment of the present invention, the gap between wound slots provides insulation. An ending disc in the form of a modular ending disc 300 may be used as the ending part of the bobbin assembly, which may comprise two inner threads and no opening.

In an exemplary embodiment of the present invention, field-control electrodes 20 may be used as well. The field-control electrodes 20 may be constructed in terms of metal rings with smooth outer edges. The metal rings may also have an outer thread to be connected to the discs.

According to an exemplary embodiment of the present invention, the bobbin assembly may comprise a plurality of isolation slots and a plurality of winding slots wherein the winding slots and the isolation slots are arranged alternatively.

According to an exemplary embodiment of the present invention, modular discs in form of a building block 100 may be used without the built-in tube, e.g. without the tube portion 100-2, just the thread on the disc portion 100-1. The width of the slots can be as narrow as necessary.

For cores whose centre leg is not round (e.g. squared), threads are not to be used. Pins or any other connectors could be used for non-round building blocks (external clamps may be necessary, or gluing the modular components). The advantage of threads is that they provide extra mechanical robustness.

According to an exemplary embodiment of the present invention, uniform discs are used as the building blocks 100, where the large and the small openings are separated by a 180° +/−5° turn angle, large and small openings are typically opposite to each other, i.e. separated by a 180° +/−5° or 180° +/−15° turn angle.

Further, the threads stop may be arranged such, that the openings of adjacent discs are separated by 90° at least. Adjacent discs may have different, e.g. small and large, openings: one of them may comprise a large opening and the other one of them may have a small opening. Furthermore, instead of threads other connection means may be used, which result into a fixed orientation of the parts to each other, like snap-in means with an angular locking feature.

The threads or other connection means might be shaped such that it is impracticable to connect discs with large openings to each other or discs with small openings to each other. This advantageously ensures the desired and beneficial alternation of large and small openings. Furthermore, the sequence of building blocks might be outlined as follows: At first, a disc with a large opening, then a separator defining the width of a slot, subsequently a disc with small opening, then a separator defining the width of an isolation slot is provided. Further, a disc with large opening is provided, followed by a separator and so on. The width of the (isolation) slots may be defined by the dimensions of the discs if the separators are omitted.

FIG. 3 shows a modular separator according to an exemplary embodiment of the present invention. A modular separator 200 as shown in FIG. 3 may be used as another modular block. The shape or the structure of the modular separator 200 resembles the building block 100, but without the disc portion 100-1.

According to an exemplary embodiment of the present invention, the modular separator 200 is configured to provide additional width to the slot, to allow creating wide and narrow slots. The modular separator 200 also comprises a first connector module 200-2 corresponding to the second connector module 100-4 of the modular discs or the building block 100. The first connector module 200-2 may be formed as an outer thread.

According to an exemplary embodiment of the present invention, the threads may lock at the same position, this is, even if separators are connected between modular discs, the small openings are still on the top side and the large openings at the bottom side. These separators are small, demand less space and are simple to manufacture, so the slot width should be adjusted by using (several) separators with a certain width.

The modular separator 200 may further comprise a not visible inner thread in terms of a second connector module. The modular separator 200 may comprise a tube portion 200-1.

The modular separator 200 may be coupled to a building block and may be used at the end of the bobbin assembly.

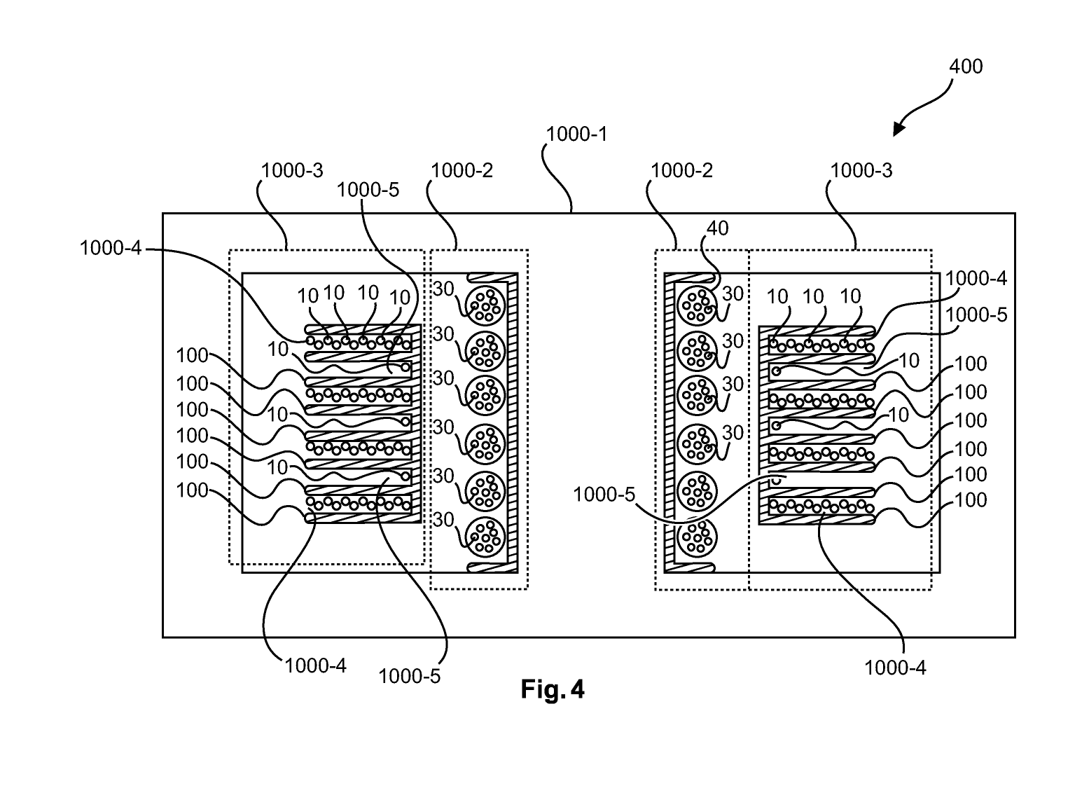

FIG. 4 shows a schematic diagram of a bobbin assembly according to an exemplary embodiment of the present invention.

An inductive electrical component 400 may comprise a soft magnetic core 1000-1, a primary winding 1000-2 and a secondary winding, the bobbin assembly 1000-3.

For the soft magnetic core 1000-1, a wide range of high-permeability materials may be used. High-permeability materials are ferromagnetic, further, sintered ferrite cores, laminated or strip wound magnetic cores made from e.g. silicon iron, amorphous or nanocrystalline materials, or powder cores made from e.g. carbonyl iron may be used to avoid high eddy currents.

The primary winding 1000-2 comprises several turns of a winding 40. The winding 40 is usually made using Litz wire, i.e. a wire with several parallel strands 30 of solid wire.

According to an exemplary embodiment of the present invention, the secondary winding bobbin assembly 1000-3 comprises a plurality of winding slots 1000-4 and a plurality of isolation slots 1000-5 and a winding 10.

According to an exemplary embodiment of the present invention, the winding slots 1000-4 may comprise one turn per layer of a winding 10. The isolation slots 1000-5 may comprise one single loop of the winding 10. The secondary winding bobbin assembly 1000-3 is built using a winding which has only one turn per layer in any given slot.

According to an exemplary embodiment of the present invention, each turn will have only one or two other turns in its immediate neighborhood. Furthermore, voltage between adjacent turns will have the minimum possible value. As a consequence of this, capacitance will be minimized and also the danger of flashovers is minimized.

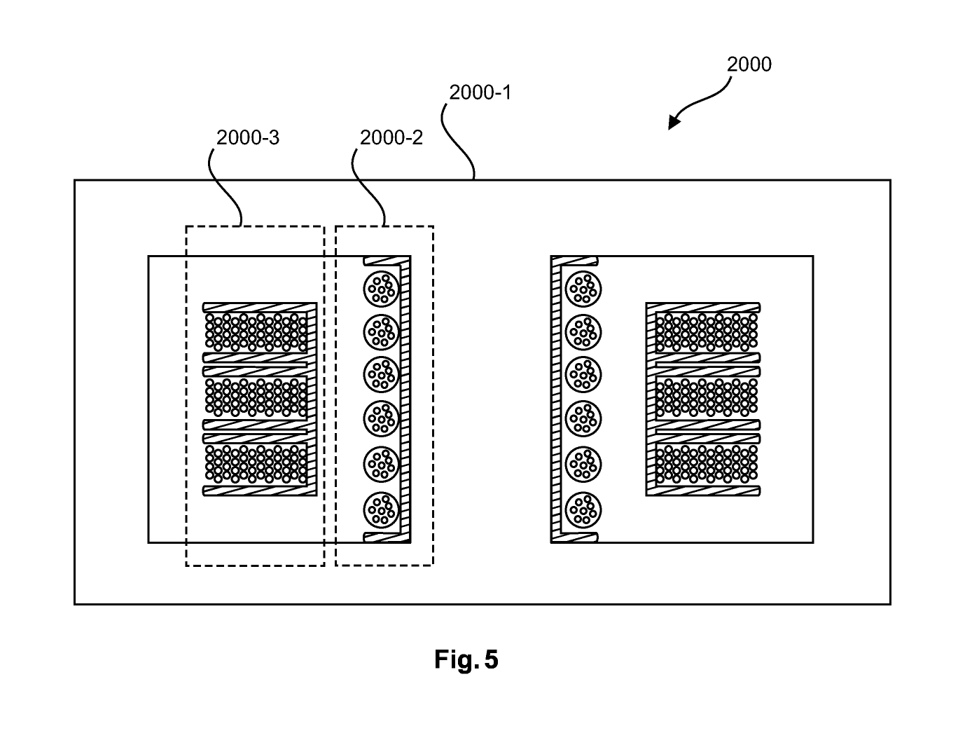

FIG. 5 shows a schematic diagram of a bobbin assembly for explaining the present invention. FIG. 5 shows the design of a high-voltage transformer 2000. The high-voltage transformer 2000 may comprise a soft magnetic core 2000-1 and a primary winding 2000-2 and a secondary winding bobbin assembly 2000-3.

Winding slots of the secondary winding bobbin assembly 2000-3 are filled with many windings 10, isolations slots of the secondary winding bobbin assembly 2000-3 may not carry a complete winding turn. Isolation slots may carry a short piece of wire connecting the winding turns in the slots adjacent to it. Usually, the length of the wire in an isolation slots may be half a turn. This corresponds to the 180° turn angle separating the large and the small opening in the adjacent discs.

Secondary winding bobbin assemblies 2000-3 may comprise many slots, with long (height) and thin walls (widths of 1 mm or less are normal). The width of the slots can be very small as well (also about 1 mm), especially the slots for insulation purposes.

The secondary winding bobbin assembly 2000-3 may be divided into multiple slots, so that the voltage difference within each slot (and hence the voltage difference between adjacent turns) becomes only a fraction of that in the secondary port. Insulation thin slots between winding slots may be necessary to avoid discharges going over the bobbin surface.

According to an exemplary embodiment of the present invention, these insulation slots are also used to return the winding wire from the top of one slot to the bottom of the next slot. Because of the insulation slots and the width of the slot walls themselves, the available winding length reduces. As a result, the height of the slots needs to be increased.

High-voltage transformers operating at high frequency do not need many turns to accommodate for the admitted core induction, meaning that the voltage between layers becomes very high, even if there are only few turns.

When winding the wire onto the secondary bobbin, it may happen that a wire is located by accident not in the intended layer but in the layer underneath it. Then it gets into contact with winding turns in a layer that is located even deeper in the slot. The voltage difference to these winding turns can be so large that a flashover occurs.

Furthermore, even the small capacitance of the usual secondary winding with slots can result in resonance frequencies that are too small for the desired operation at high frequency.

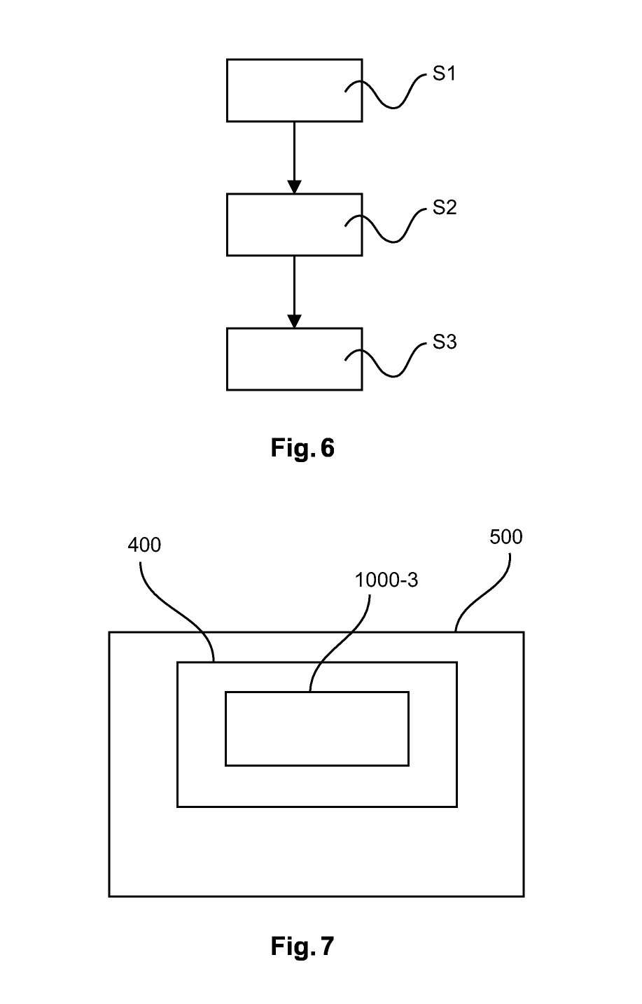

FIG. 6 shows a schematic diagram of a flow-chart diagram of a method for producing a bobbin assembly according to an exemplary embodiment of the present invention.

As a first step of the method, providing Si a first building block 100 comprising a first opening 100-5 and guiding a wire through the first opening 100-5 into the first building block 100 may be performed. In other words, the wire is guided via the first opening into the bottom winding slot. Then this bottom winding slot is filled with winding turns.

As a second step of the method, providing S2 a second building block 100 comprising a second opening 100-6 being larger than the first opening 100-5 and guiding the wire through the second opening 100-6 into the second building block 100 is performed. The wire is guided via the opening into the adjacent isolation slot.

As a third step of the method, assembling S3 the secondary winding bobbin assembly 1000-3 comprising: a plurality of winding slots 1000-4 and a plurality of isolation slots 1000-5 using the first and second building blocks 100 is performed.

The steps of the method may be iterated for a modular fabrication of the b bobbin assembly.

FIG. 7 shows a schematic diagram of a medical imaging system according to an exemplary embodiment of the present invention. A medical imaging system 500 may comprise at least one inductive electrical component 400 with a secondary winding bobbin assembly 1000-3.

It has to be noted that embodiments of the present invention are described with reference to different subject-matters. In particular, some embodiments are described with reference to method type claims, whereas other embodiments are described with reference to device type claims.

However, a person skilled in the art will gather from the above and the foregoing description that, unless otherwise notified, in addition to any combination of the features belonging to one type of subject-matter also any combination between features relating to different subject-matters is considered to be disclosed with this application.

However, all features can be combined providing synergetic effects that are more than the simple summation of these features.

While the invention has been illustrated and described in detail in the drawings and foregoing description, such illustration and description are to be considered illustrative or exemplary and not restrictive; the present invention is not limited to the disclosed embodiments. Other variations to the disclosed embodiments can be understood and effected by those skilled in the art and practicing the claimed invention, from a study of the drawings, the disclosure, and the appended claims.

In the claims, the word “comprising” does not exclude other elements or steps and the indefinite article “a” or “an” does not exclude a plurality. Any reference signs in the claims should not be considered as limiting the scope.

1. A bobbin assembly comprising:
a plurality of winding slots, each of which comprises a winding with multiple loops of the winding with only one turn per layer; and
a plurality of isolation slots, each of which comprises one single loop of the winding, and each of the isolation slots is adjacent to at least one winding slot of the plurality of winding slots, and each of the winding slots is adjacent to at least one isolation slot of the plurality of isolation slots.

2. The bobbin assembly according to claim 1, wherein each winding slot; of the plurality of winding slots and each isolation slot of the plurality of isolation slots is configured to receive a secondary winding.

3. The bobbin assembly according to claim 1, wherein each winding slot of the plurality of winding slots and each isolation slot of the plurality of isolation slots is formed by a building block.

4. The bobbin assembly according to claim 3, wherein each building block of the building blocks comprises a first connector module and a second connector module and the first connector module and the second connector module are configured to be coupled with an adjacent building block.

5. The bobbin assembly according to claim 4, wherein the first connector module is an inner thread and the second connector module is an outer thread.

6. The bobbin assembly according to claim 4, wherein each building block of the building blocks comprises an opening, which is configured to pass the winding through.

7. The bobbin assembly according to claim 3, wherein each building block of the building blocks is substantially disc-shaped.

8. The bobbin assembly, according to claim 7, wherein each building block of the building blocks comprises a disc portion and a tube portion.

9. The bobbin assembly according to claim 1, wherein the bobbin assembly is configured to be operated with a voltage of up to 1 kV, preferably of up to 10 kV and particularly preferred of up to 80 kV.

10. A transformer comprising the bobbin assembly according to claim 1, wherein the bobbin assembly is a secondary winding bobbin assembly in a transformer further comprising a primary winding bobbin assembly and wherein a boosting turns ratio is higher than 1, preferably higher than 4 and particularly preferred higher than 10.

11. An inductive electrical component comprising at least one coil comprising a bobbin assembly according to claim 1.

12. A medical imaging system comprising at least one transformer comprising the bobbin assembly or comprising at least one inductive electrical component according to claim 11.

13. A method for producing a bobbin assembly, the method comprising the steps of:
providing (S1) a first building block comprising a first opening and guiding a wire through the first opening into the first building block;
providing (S2) a second building block comprising a second opening being larger than the first opening and guiding the wire through the second opening into the second building block; and
assembling (S3) by repeating steps S1 and S2, the bobbin assembly comprising: a plurality of winding slots, each of which comprises a winding with multiple loops of the winding with one turn per layer; and a plurality of isolation slots, each of which comprises one single loop of the winding, using the first and second building blocks and each of the isolation slots is adjacent to at least one winding slot of the plurality of winding slots, and each of the winding slots is adjacent to at least one isolation slot of the plurality of winding slots.
